(19) United States
(12) Patent Application Publication
(10) Pub. No.: US 2016/0316489 A1
(43) Pub. Date: Oct. 27, 2016

(54) CHANNEL SCAN METHOD AND ASSOCIATED DEVICE FOR REDUCING CHANNEL SCAN TIME

(71) Applicant: Mediatek Inc., Hsin-Chu (TW)

(72) Inventors: Ching-Yu Kuo, Hsinchu City (TW); Sung-Chien Tang, Taoyuan City (TW)

(21) Appl. No.: 14/918,531

(22) Filed: Oct. 20, 2015

Related U.S. Application Data
(60) Provisional application No. 62/150,309, filed on Apr. 21, 2015.

(51) Int. Cl. H04W 74/08; H04L 27/00

(52) U.S. Cl. CPC H04W 74/0808; H04L 27/0006; H04W 84/12

(57) ABSTRACT

A channel scan method includes: configuring a receiving circuit to perform a single signal reception of a first bandwidth to generate a signal reception result; and performing channel scan upon the signal reception result to detect a channel status of each channel having a second bandwidth smaller than the first bandwidth. In addition, a channel scan device has a receiving circuit, a control circuit, and a scan circuit. The control circuit controls the receiving circuit to perform a single signal reception of a first bandwidth to generate a signal reception result. The scan circuit performs channel scan upon the signal reception result to detect a channel status of each channel having a second bandwidth smaller than the first bandwidth.

### CROSS REFERENCE TO RELATED APPLICATIONS

This application claims the benefit of U.S. provisional application No. 62/150,309, filed on Apr. 21, 2015 and incorporated herein by reference.

### BACKGROUND

The present invention relates to performing channel scan for wireless communications, and more particularly, to a channel scan method and an associated device capable of finding a target channel (e.g. a busy channel) within a short time.

When performing data transmission upon channels in a wireless local area network, it is important to perform detection upon the channel state of these channels in advance to check if there is an available access point (AP). An appropriate state detection on channels may also effectively avoid data collision. A clear channel assessment (CCA) is generally utilized to indicate channel state. The CCA is a logical function found within physical layers which determines the current state of a wireless medium. This function is found in IEEE 802.11 networks and may help avoid competition. For example, when it is found that a channel is occupied by another equipment, the transmission operation for this channel will be skipped.

The recently developed IEEE 802.11 specification provides high-throughput wireless local area networks (WLANs) on the 5 GHz band. Compared to 802.11n, 802.11ac has the advantages of wider radio frequency (RF) bandwidth (up to 160 MHz), more multi-input multi-output (MIMO) spatial streams (up to eight), downlink multi-user MIMO (up to four clients), and high-density modulation (up to 256-QAM). Further, the IEEE 802.11ac specification introduces various types of bandwidth such as 80 MHz, 160 MHz, noncontiguous 80+80, which require the station to operate in 5 GHz.

When detecting CCAs of channels, listening to each channel is performed sequentially and in a step-by-step manner. Further, the CCA detection will not ignore any channel. This causes the overall channel scan time in conventional schemes to be too long, thus lowering the efficiency of the channel scan procedure.

Refer to Table 1 in conjunction with FIG. 1. Table 1 illustrates the actual CCA statuses of channels in noncontiguous 160+160 MHz, wherein the first segment of 160+160 MHz covers channels 36-64, and the second segment of 160+160 MHz covers channels 100-128. FIG. 1 is a flowchart illustrating operations of a conventional channel scan method. Specifically, the station (STA) performs channel scan (for simplicity, referred to as a passive channel scan) upon channels 36, 40, 44, 48, 52, 56, 60, 64, 100, 104, 108, 112, 116, 120, 124 and 128, which are 5180, 5200, 5220, 5240, 5260, 5280, 5300, 5320, 5500, 5520, 5540, 5560, 5580, 5600, 5620 and 5640 MHz, respectively, wherein there is only one access point (AP) which exists in channel 44. It takes 110 ms to listen to the CCA of each channel, wherein the bandwidth of each channel is 20 MHz, and therefore the station has to spend a total of 1760 ms (110 ms×16) to perform a full scan for all 16 channels. The flow in FIG. 1 can be detailed as follows:

Step 101: Switch to Channel 36 and check if there is any packet within 110 ms;

Step 102: Switch to Channel 40 and check if there is any packet within 110 ms;

Step 103: Switch to Channel 44 and check if there is any packet within 110 ms (packets are found in Channel 44);

Step 104: Switch to Channel 48 and check if there is any packet within 110 ms;

Step 105: Switch to Channel 52 and check if there is any packet within 110 ms;

Step 106: Switch to Channel 56 and check if there is any packet within 110 ms;

Step 107: Switch to Channel 60 and check if there is any packet within 110 ms;

Step 108: Switch to Channel 64 and check if there is any packet within 110 ms;

Step 109: Switch to Channel 100 and check if there is any packet within 110 ms;

Step 110: Switch to Channel 104 and check if there is any packet within 110 ms;

Step 111: Switch to Channel 108 and check if there is any packet within 110 ms;

Step 112: Switch to Channel 112 and check if there is any packet within 110 ms;

Step 113: Switch to Channel 116 and check if there is any packet within 110 ms;

Step 114: Switch to Channel 120 and check if there is any packet within 110 ms;

Step 115: Switch to Channel 124 and check if there is any packet within 110 ms;

Step 116: Switch to Channel 128 and check if there is any packet within 110 ms.

TABLE 1

| | Channel (bandwidth 20 MHz) | | | |
|---|---|---|---|---|
| | 36 | 40 | 44 | 48 |
| CCA Status | Not | Not | Busy | Not |
| | Busy | Busy | | Busy |
| | Channel (bandwidth 20 MHz) | | | |
| | 52 | 56 | 60 | 64 |
| CCA Status | Not | Not | Not | Not |
| | Busy | Busy | Busy | Busy |
| | Channel (bandwidth 20 MHz) | | | |
| | 100 | 104 | 108 | 112 |
| CCA Status | Not | Not | Not | Not |
| | Busy | Busy | Busy | Busy |
| | Channel (bandwidth 20 MHz) | | | |
| | 116 | 120 | 124 | 128 |
| CCA Status | Not | Not | Not | Not |
| | Busy | Busy | Busy | Busy |

Since packets are found in Channel 44, after scanning all remaining channels, the station will receive beacon or probe responses from an AP in Channel 44. From the above, it can be seen that time is wasted by performing channel scan in the conventional step-by-step manner. Therefore, there is a need for an innovative channel scan method capable of accomplishing the channel scan procedure in a short time.

### SUMMARY

Embodiments of the present invention provide a two-phase channel scan procedure to solve the problems of the related arts. Specifically, the first phase channel scan captures response signals over wide bandwidths, and generates a clear channel assessment (CCA) status. The second phase sets a channel which is determined to be busy according to the CCA status as a primary channel, and then receives beacons or probe response from this primary channel. Embodiments of the present invention may avoid performing full channel scan in a step-by-step manner, thus reducing the overall channel scan time.

According to a first embodiment of the present invention, a channel scan method is provided. The channel scan method includes: configuring a receiving circuit to perform a single signal reception of a first bandwidth to generate a signal reception result; and performing channel scan upon the signal reception result to detect a channel status of each channel having a second bandwidth smaller than the first bandwidth.

According to a second embodiment of the present invention, a channel scan device is provided. The channel scan device includes a receiving circuit, a control circuit and a scan circuit. The control circuit is arranged to control the receiving circuit to perform a single signal reception of a first bandwidth to generate a signal reception result. The scan circuit is arranged to perform channel scan upon the signal reception result to detect a channel status of each channel having a second bandwidth smaller than the first bandwidth.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating operations of a conventional channel scan method.

FIG. 2 is a diagram illustrating a channel scan device according to an embodiment of the present invention.

FIGS. 3-4 area flowchart illustrating operations of a channel scan method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

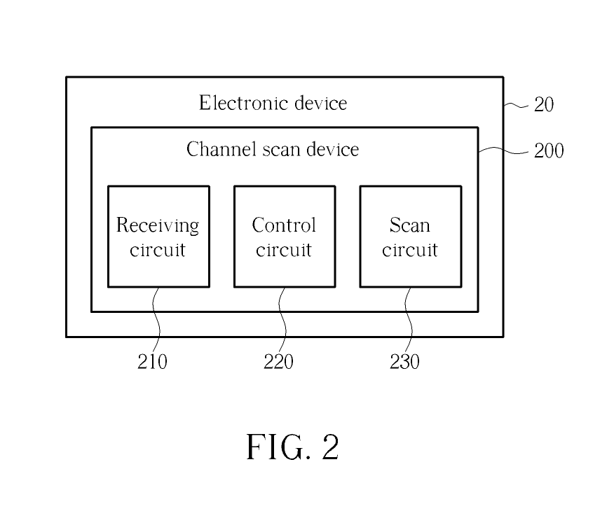

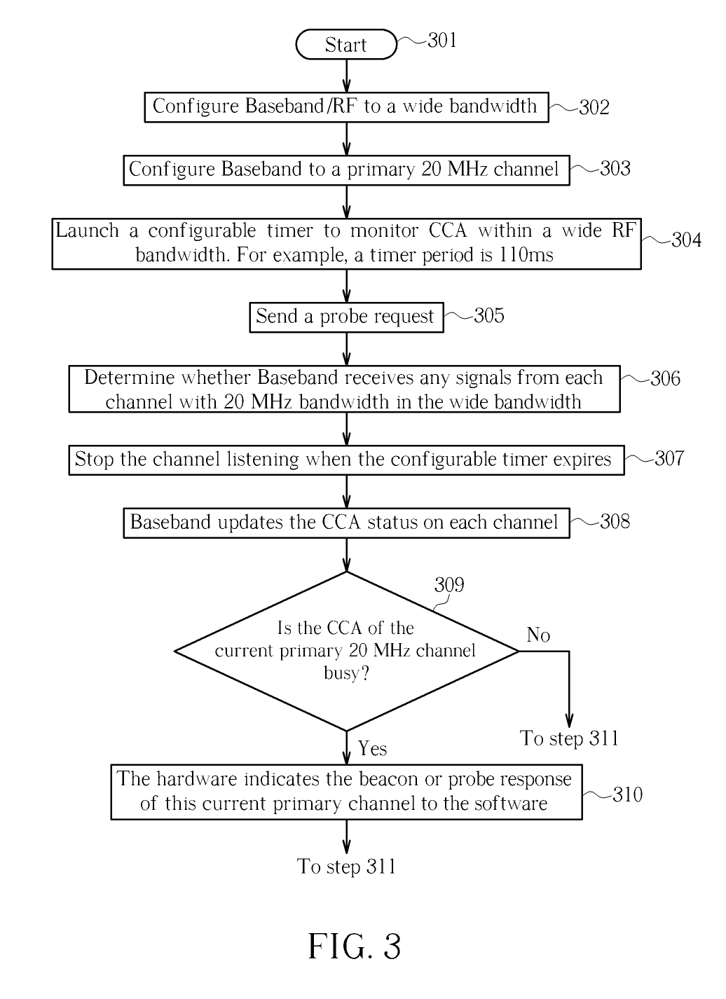

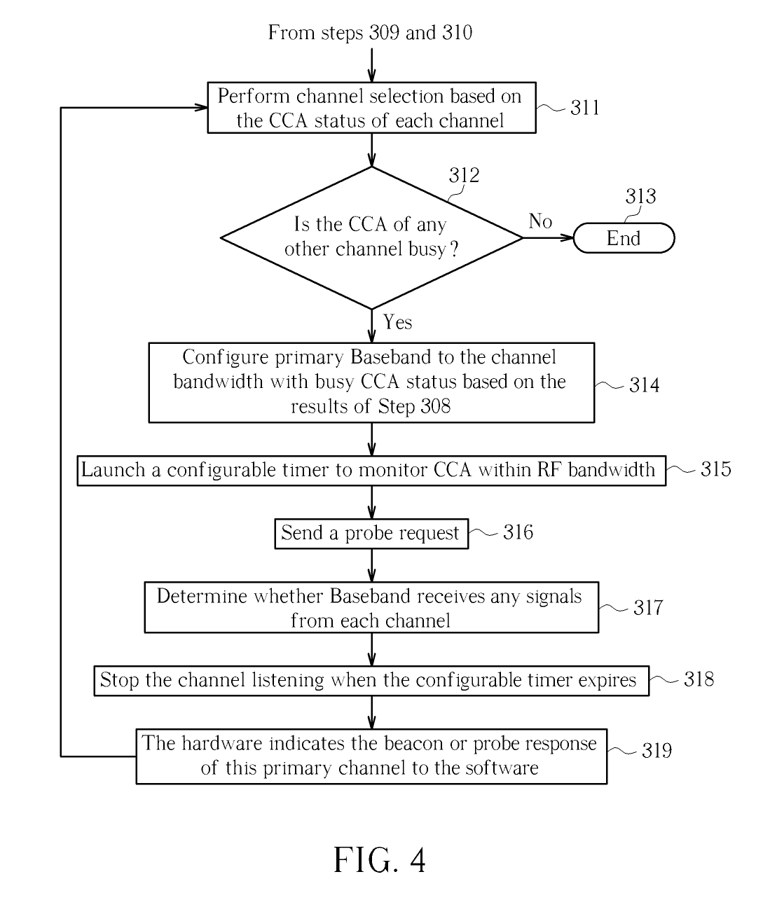

FIG. 2 is a diagram illustrating a channel scan device according to an embodiment of the present invention. The channel scan device 200 may be part of an electronic device 20 such as a mobile phone, a tablet, or a wearable device. In this embodiment, the channel scan device 200 includes a receiving circuit 210, a control circuit 220 and a scan circuit 230. The control circuit 220 is arranged to control the receiving circuit 210 to perform a single signal reception of a first bandwidth to generate a signal reception result. The scan circuit 230 is arranged to perform channel scan upon the signal reception result to detect a channel status of each channel having a second bandwidth. Please note that the first bandwidth should be configured to be larger than the second bandwidth. For instance, in the following example of FIGS. 3-4, the first bandwidth is configured to be non-contiguous 160+160 MHz, which is much larger than a 20-MHz bandwidth employed by conventional schemes.

By means of illustration, but not limitation, the scan circuit 230 may begin channel scan with a default channel selected from the signal reception result regardless of a channel status of the default channel. That is, the selection for the default channel can be pre-defined or arbitrary.

In addition, the channel scan techniques employed by the present invention can either be active or passive. For example, when active scan is enabled, the scan circuit 230 will send a probe request through the default channel; however, this step can be skipped in passive scan.

Specifically, when a passive scan is enabled, a station will listen to broadcast messages (beacons, etc.) that are periodically transmitted by Wi-Fi APs. When an active scan is enabled, the station transmits a probe request message over a Wi-Fi channel and then monitors the Wi-Fi channel for a probe response message sent by a Wi-Fi AP. If a probe response is detected, the station may thus discover the Wi-Fi AP on that channel. Since one skilled in the art will be familiar with techniques related to active scan and passive scan, detailed illustrations are omitted here for brevity.

The scan circuit 230 is arranged to select a specific channel detected from the signal reception result according to a channel status of the specific channel, and perform channel listening upon the specific channel. Note that, when the active scan is enabled, the scan circuit 230 will send a probe request by the specific channel.

More particularly, the aforementioned channel status may include a clear channel assessment (CCA) status. When a CCA status of a specific channel detected from the signal reception result indicates that the specific channel is busy, the scan circuit 230 will select the specific channel and perform channel listening upon the selected channel (the specific channel with a CCA state “Busy”).

Further, when a CCA status of a specific channel detected from the signal reception result indicates that the specific channel is not busy, the scan circuit 230 skips the specific channel without performing channel listening, so that this channel (the specific channel with a CCA state “Not Busy”) becomes a skipped channel.

In some embodiments, when a specific channel detected from the signal reception result receives a beacon response or a probe response, hardware of this electronic device 20 informs software of the electronic device 20 of the beacon response or the probe response. In some embodiments, each channel monitored by the channel scan may comply with an 802.11ac or 802.11n or other wireless communications specification.

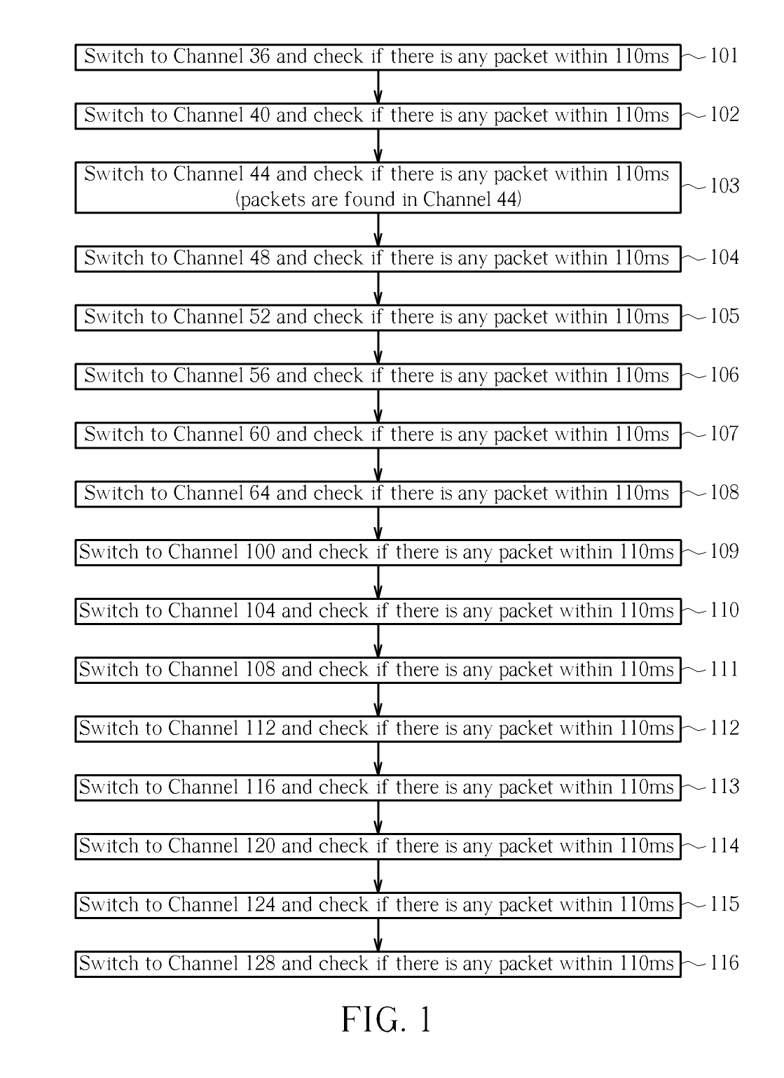

Compared to the conventional scheme illustrated in FIG. 1 and Table 1, the station employing the scheme proposed by the present invention spends less time performing channel scan. Refer to FIGS. 3-4 in conjunction with Table 1. FIGS. 3-4 is a flowchart illustrating operations of a channel scan method according to an embodiment of the present invention, wherein the steps shown in FIG. 4 are executed after the steps shown in FIG. 3. If the result is substantially the same, the steps are not required to be executed in the exact order shown in FIGS. 3-4. In this example, the bandwidth is non-contiguous 160+160 MHz, wherein the first segment of 160+160 MHz covers channels 36-64, and the second segment of 160+160 MHz covers channels 100-128. The method shown in FIG. 3 may be employed by the channel scan device 200, and can be briefly summarized as follows.

Step 301: Start.

Step 302: Configure Baseband/RF to a wide bandwidth (e.g. a bandwidth larger than 20 MHz).

Step 303: Configure Baseband to a primary 20 MHz channel (a default channel). In this example, channel 36 (5180 MHz) is selected as the default channel.

Step 304: Launch a configurable timer to monitor CCA within a wide RF bandwidth. For example, a timer period is 110 ms.

Step 305: Send a probe request. This step can be skipped if passive scan is enabled.

Step 306: Determine whether Baseband receives any signals from each channel with 20 MHz bandwidth in the wide bandwidth.

Step 307: Stop the channel listening when the configurable timer expires.

Step 308: Baseband updates the CCA status on each channel.

Step 309: Is the CCA of the current primary 20 MHz channel busy? If yes, go to step 310; otherwise, go to step 311. The current primary 20 MHz channel would be the default channel (e.g. channel 36) at the beginning of the channel scan procedure, and is then updated to a different channel with a CCA state “Busy”.

Step 310: The hardware indicates the beacon or probe response of this current primary 20 MHz channel to the software if any.

Step 311: Perform 20 MHZ channel selection based on the CCA status of each 20 MHZ channel (all channels except for the current primary 20 MHZ channel, e.g. channels other than channel 36).

Step 312: Is the CCA of any other 20 MHZ channel busy? If yes, go to Step 314; otherwise, go to Step 313.

Step 313: End.

Step 314: Configure primary 20 MHz channel (Baseband) to the channel bandwidth 20 MHz with busy CCA status (i.e. channel 44) based on the results of Step 308 (i.e. the CCA status shown in Table 1).

Step 315: Launch a configurable timer to monitor CCA within RF bandwidth. For example, a timer period is 110 ms.

Step 316: Send a probe request. This step can be skipped if passive scan is enabled.

Step 317: Determine whether Baseband receives any signals from each channel with 20 MHz bandwidth.

Step 318: Stop the channel listening when the configurable timer expires.

Step 319: The hardware indicates the beacon or probe response of this primary 20 MHz channel to the software, because there is an AP operating in channel 44.

In Step 302, a wide bandwidth larger than 20 MHz is employed. For example, the Baseband/RF may be configured to be 160+160 MHz in order to finish the channel listening as soon as possible. However, the bandwidth is not limited to the current embodiment. In other embodiments, the bandwidth can be 20+20, 20+40, 20+80, 20+160, 40+40, 40+80, 40+160, 80+80, 80+160 or any other applicable bandwidths. In Step 303, Channel 36 (5180 MHz) is selected as the default channel. Step 303 may be skipped based on design requirements, however. The configurable timer starts to count in Step 304, and expires in Step 307. The timer period may be 110 ms. Further, the configurable timer may be a one shot timer.

In step 305, when the active scan is enabled, a probe request is sent to the default channel. Step 305 may be skipped when the passive scan is enabled. Step 306 determines whether Baseband receives any signals from each channel within the wide bandwidth (e.g. channels 36, 40, 44, 48, 52, 56, 60, 64, 100, 104, 108, 112, 116, 120, 124 and 128), wherein the bandwidth of each channel is 20 MHz. In Step 308, since the CCA status of each channel is collected, Baseband may update the CCA status to find the busy channel. Step 309 determines whether the CCA status of the current primary 20 MHz channel is “Busy”. Since the current primary 20 MHz channel is initially set by the default channel in Step 303, the CCA status of the default channel (e.g. Channel 36) is checked in Step 309.

Because the CCA status of Channel 36 is not busy, the hardware will not inform the software of the beacon or probe response of Channel 36. Step 309 will be repeated on a next channel (i.e. Channel 40). When Step 309 is performed on Channel 44 which is busy, the hardware informs the software of the beacon or probe response of Channel 44. The entire flow may then end or may continue to determine the remaining channels (i.e. the channels next to Channel 44) based on design requirements.

Further, when performing channel scan for a next time, the primary 20 MHz channel (the default channel) may be automatically configured to Channel 44. This is for illustrative purposes, and not meant to be a limitation. For example, when performing a channel scan for a next time, the primary 20 MHz channel (the default channel) may still be configured to Channel 36 or may be any other channel.

Regarding Step 310, the device in this current primary channel might not receive any beacon or probe response. As a result, the hardware performs the packet indication only when receiving packets.

Steps 312 determines whether any other channel has a busy CCA status. If there is no channel with busy CCA status, the flow ends; otherwise, the flow goes to Step 314. Since the theories and operations in Steps 314-319 are similar to those in Steps 302-308, detailed descriptions of Steps 314-319 are omitted here for brevity.

It can be seen from the above that the overall channel scan time is greatly reduced by utilizing the method and apparatus proposed by the present invention. The first phase captures signals over a wide bandwidth and generates a CCA status result, and the second phase switches to the primary 20 MHz channel with busy CCA status and receives the beacon or probe response. In this example, the present invention spends a total of 220 ms for the entire channel scan procedure (110 ms for CCA detection for all channels, and another 110 ms for receiving beacon and probe response from the AP in channel 44), while the aforementioned conventional method will have spent 1760 ms. Therefore, the two-phase channel scan procedure proposed by the present invention may greatly reduce the time required for channel scan.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A channel scan method, comprising:
configuring a receiving circuit to perform a single signal reception of a first bandwidth to generate a signal reception result; and
performing channel scan upon the signal reception result to detect a channel status of each channel having a second bandwidth smaller than the first bandwidth.

2. The channel scan method of claim 1, wherein the step of performing the channel scan upon the signal reception result to detect the channel status of each channel comprises:
beginning the channel scan with a default channel selected from the signal reception result regardless of a channel status of the default channel.

3. The channel scan method of claim 2, further comprising:
sending a probe request by the default channel when an active scan is enabled.

4. The channel scan method of claim 1, further comprising:
selecting a specific channel detected from the signal reception result according to a channel status of the specific channel; and
performing channel listening upon the specific channel.

5. The channel scan method of claim 4, further comprising:
sending a probe request by the specific channel when an active scan is enabled.

6. The channel scan method of claim 1, wherein the channel status comprises a clear channel assessment (CCA) status.

7. The channel scan method of claim 6, further comprising:
when a CCA status of a specific channel detected from the signal reception result indicates that the specific channel is busy, selecting the specific channel and performing channel listening upon the specific channel.

8. The channel scan method of claim 6, further comprising:
when a CCA status of a specific channel detected from the signal reception result indicates that the specific channel is not busy, skipping the specific channel, where no channel listening is performed upon the specific channel.

9. The channel scan method of claim 1, wherein the receiving circuit is part of an electronic device; and when a specific channel detected from the signal reception result receives a beacon response or a probe response, hardware of the electronic device informs software of the electronic device of the beacon response or the probe response.

10. A channel scan device, comprising:
a receiving circuit;
a control circuit, arranged to control the receiving circuit to perform a single signal reception of a first bandwidth to generate a signal reception result; and
a scan circuit, arranged to perform channel scan upon the signal reception result to detect a channel status of each channel having a second bandwidth smaller than the first bandwidth.

11. The channel scan device of claim 10, wherein the scan circuit begins the channel scan with a default channel selected from the signal reception result regardless of a channel status of the default channel.

12. The channel scan device of claim 11, wherein the scan circuit sends a probe request by the default channel when an active scan is enabled.

13. The channel scan device of claim 10, wherein the scan circuit selects a specific channel detected from the signal reception result according to a channel status of the specific channel, and performs channel listening upon the specific channel.

14. The channel scan device of claim 13, wherein the scan circuit sends a probe request by the specific channel when an active scan is enabled.

15. The channel scan device of claim 10, wherein the channel status comprises a clear channel assessment (CCA) status.

16. The channel scan device of claim 15, wherein when a CCA status of a specific channel detected from the signal reception result indicates that the specific channel is busy, the scan circuit selects the specific channel and performs channel listening upon the specific channel.

17. The channel scan device of claim 15, wherein when a CCA status of a specific channel detected from the signal reception result indicates that the specific channel is not busy, the scan circuit skips the specific channel, where no channel listening is performed upon the specific channel.

18. The channel scan device of claim 10, wherein the receiving circuit is part of an electronic device; and when a specific channel detected from the signal reception result receives a beacon response or a probe response, hardware of the electronic device informs software of the electronic device of the beacon response or the probe response.
